(19) United States
(12) Patent Application Publication
(10) Pub. No.: US 2014/0074697 A1
(43) Pub. Date: Mar. 13, 2014

(54) AUTOMATED CLEARING HOUSE TRANSACTION SCORING

(71) Applicant: Argos Risk LLC, St. Louis Park, MN (US)

(72) Inventor: Steve Foster, Eden Prairie, MN (US)

(73) Assignee: Argos Risk LLC, St. Louis Park, MN (US)

(21) Appl. No.: 14/024,372

(22) Filed: Sep. 11, 2013

Related U.S. Application Data
(60) Provisional application No. 61/699,339, filed on Sep. 11, 2012.

(51) Int. Cl. G06Q 20/02

(52) U.S. Cl. CPC G06Q 20/023
USPC 705/39

(57) ABSTRACT

Embodiments provide calculated scores allowing users to quickly and easily evaluate credit and ACH risk associated with a financial institution's ACH originators. The index score is computed using a 0 to 100 scale with 100 reflecting a low risk ACH relationship and 0 indicating significant potential risk. The index score integrates the standard entry class code, standard entry class code return risk percentage, industry risk factors, origination set volume, origination set frequency, origination set aggregate peak exposure risk, third party financial information, public record information, economic risk metrics, and customized risk profile.

### RELATED APPLICATION

This application claims the benefit of U.S. Provisional Application No. 61/699,339, filed Sep. 11, 2012, which is hereby fully incorporated herein by reference.

### FIELD OF THE INVENTION

The present invention relates generally to automated clearing house transactions, and more particularly, to the calculation and scoring of risk associated with those transactions.

### BACKGROUND OF THE INVENTION

Automated Clearing House (ACH) is an electronic network for financial transactions in the United States, processing large volumes of credit and debit transactions. Financial service companies and third party payment processing companies have an interest in managing the risk involved in these transactions. Further, this risk is often difficult to measure across industries and between companies of varying sizes.

Thus, there is a need for an automated universal metric that can be used to quickly and easily evaluate credit and ACH risk associated with an ACH originator.

### SUMMARY OF THE INVENTION

Systems and methods of embodiments of the present application substantially meet the aforementioned needs of the industry. Embodiments provide machine-implemented processes for calculating index scores allowing users to quickly and easily evaluate credit and ACH risk associated with a financial institution's or third party processors' ACH originators. In an embodiment, the index score is computed using a 0 to 100 scale with 100 reflecting a low risk ACH relationship and 0 indicating significant potential risk. In an embodiment, the index score integrates the standard entry class code, standard entry class code return risk percentage, industry risk factors, origination set volume, origination set frequency, origination set aggregate peak exposure risk, third party financial information, public record information, economic risk metrics, and customized risk profile. In embodiments, the index score integrates other, additional, or fewer pieces of data or information. In embodiments, using the index score, the credit risk associated with ACH originator relationships can be easily and efficiently managed.

According to an embodiment, a method for calculating a numeric ACH score for an ACH originator comprises evaluating a standard entry class code of the ACH originator; evaluating a standard entry class code return risk percentage of the ACH originator; evaluating one or more industry risk factors for the ACH originator; evaluating an origination set volume for the ACH originator; evaluating an origination set aggregate peak exposure risk for the ACH originator; evaluating actual transaction data for the ACH originator; evaluating third party financial data for the ACH originator; evaluating public record data for the ACH originator; evaluating one or more economic risk metrics for the ACH originator; evaluating a customized risk profile for the ACH originator; and displaying the calculated numeric ACH score.

According to an embodiment, a system for calculating a numeric index score for an ACH originator, the system comprises a processing engine configured to calculate the numeric index score, the processing engine including a database configured to store at least one of a standard entry class code for the ACH originator, a standard entry class code return risk percentage for the ACH originator, one or more industry risk factors for the ACH originator, an origination set volume for the ACH originator, an origination set aggregate peak exposure risk for the ACH originator, actual transaction data for the ACH originator, third party financial data for the ACH originator, public record data for the ACH originator, one or more economic risk metrics for the ACH originator, or a customized risk profile for the ACH originator, and a processor configured to execute database-specific calls to retrieve data from the database and evaluate the retrieved data to calculate the numeric index score for the ACH originator; and a user interface operably coupled to the processing engine and configured to display the numeric index score.

According to an embodiment, a method for managing credit risk associated with ACH originators comprises evaluating an ACH index score, the ACH index score calculated based on an evaluation of a standard entry class code of the ACH originator, a standard entry class code return risk percentage of the ACH originator, one or more industry risk factors for the ACH originator, an origination set volume for the ACH originator, an origination set aggregate peak exposure risk for the ACH originator, actual transaction data for the ACH originator, third party financial data for the ACH originator, public record data for the ACH originator, one or more economic risk metrics for the ACH originator, and a customized risk profile for the ACH originator; and conducting a credit transaction with the ACH originator based on the ACH index score.

According to an embodiment, a method for generating an index score for an ACH originator comprises evaluating at least one of a standard entry class code of the ACH originator, a standard entry class code return risk percentage of the ACH originator, one or more industry risk factors for the ACH originator, an origination set volume for the ACH originator, an origination set aggregate peak exposure risk for the ACH originator, actual transaction data for the ACH originator, third party financial data for the ACH originator, public record data for the ACH originator, one or more economic risk metrics for the ACH originator, or a customized risk profile for the ACH originator, wherein the index score reflects the riskiness of entering into a credit transaction with the ACH originator.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a block diagram of an index scoring system, according to an embodiment.

FIGS. 2A and 2B are an annotated spreadsheet explaining aspects of the index scoring, according to an embodiment.

FIGS. 3A-3C are screenshots for the user interface of the system of FIG. 1.

FIG. 4 is a chart of an indicator and corresponding condition for display by the index scoring system according to a particular index scoring, according to an embodiment.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

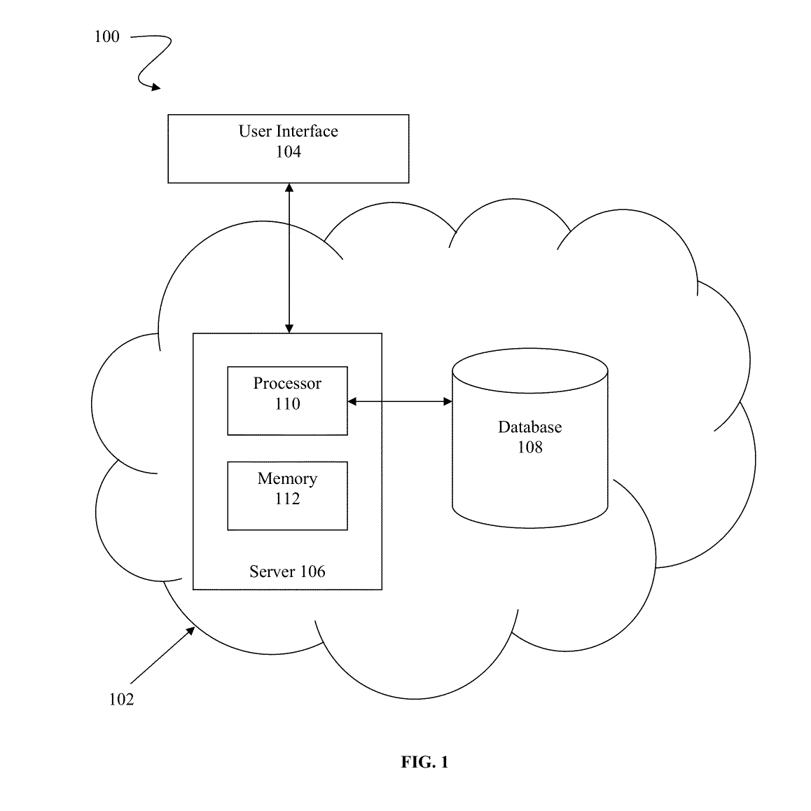

Referring to FIG. 1, an index scoring system 100 is depicted, according to an embodiment. Index scoring system 100 generally includes a cloud-based processing engine 102 and a user interface 104. While index scoring system 100 is described herein with respect to a cloud-based system, embodiments of the invention can be performed in a cloud computing, client-server, or standalone computer processing environment, or any combination thereof.

In an embodiment, processing engine 102 generally includes server 106 and database 108. Processing engine 102 embodies the computation, software, data access, and storage services that are provided to users over a network. The components of processing engine 102 can be located in a singular “cloud” or network, or spread among many clouds or networks. End-user knowledge of the physical location and configuration of components of processing engine 102 is not required.

Server 102 generally includes processor 110 and memory 112. Processor 110 can be any programmable device that accepts digital data as input, is configured to process the input according to instructions or algorithms, and provides results as outputs. In an embodiment, processor 110 can be a central processing unit (CPU) configured to carry out the instructions of a computer program. Processor 110 is therefore configured to perform basic arithmetical, logical, and input/output operations.

Memory 112 can comprise volatile or non-volatile memory as required by the coupled processor 110 to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

As depicted in FIG. 1, server 102 interfaces with database 108 via processor 110. Specifically, processor 110 can execute database-specific calls to store and retrieve data from database 108. Database 108 can comprise any organized collection of data. In embodiments, database 108 can comprise simple non-volatile memory as part of a computer. In embodiments, database 108 can comprise database management systems such as Oracle, IBM DB2, MySQL, or Microsoft SQL Server, for example. As shown in FIG. 1, database 108 is discrete from server 106. In another embodiment, database 108 is a part of server 106. In other embodiments, database 108 can comprise multiple databases spread out over the network. The underlying data stored, for example, by database 108, can be acquired, queried, or otherwise obtained from providers of business information insight and market forecast data providers. Data can be populated into database 108 through continuous, automated data transmissions, in an embodiment.

User interface 104 comprises an interface for allowing access by a user to the arithmetical, logical, and input and output operations of processor 110. Particularly, in an embodiment, user interface 104 allows access to the calculated ACH index score and the associated risk. In embodiments, processing engine 102 can include user interface 104, but is shown in FIG. 1 as separate for ease of explanation. In embodiments, user interface 104 can be accessed by desktop computer, laptop computer, tablet, smartphone, PDA, or any other suitable device. In an embodiment, user interface 104 comprises an internet-protocol based webpage interface.

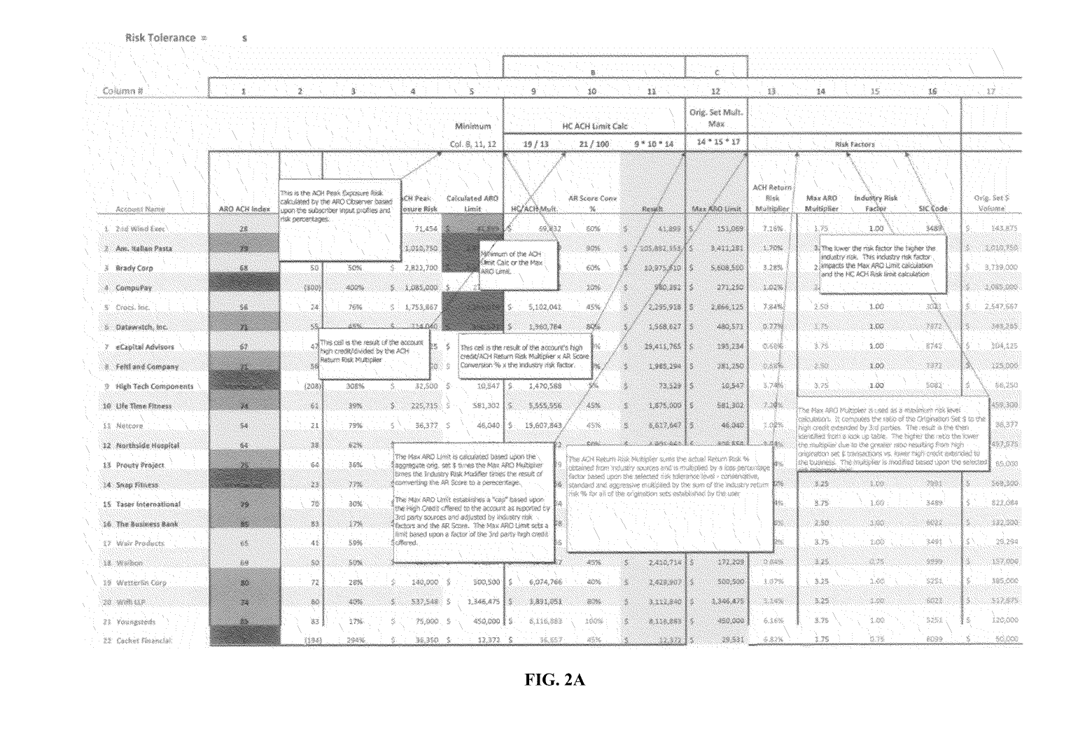

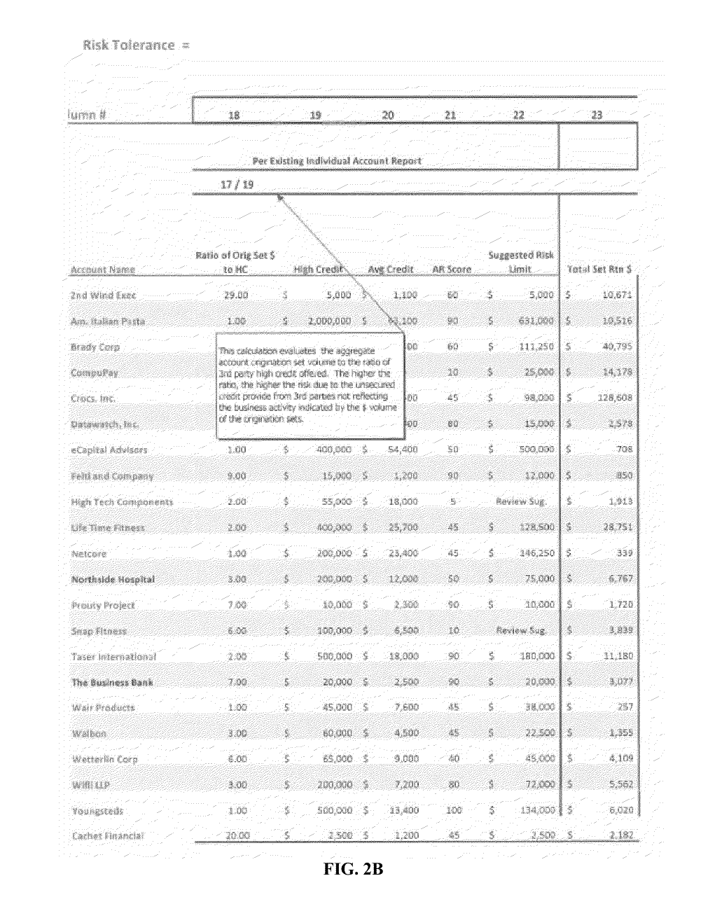

Referring to FIGS. 2A and 2B, in an embodiment, an ACH index score is computed by processing engine 102 using a 0 to 100 scale with 100 reflecting a low risk ACH relationship and 0 indicating significant potential risk. Other index scale scoring values can also be used in other embodiments, such as numeric, alphanumeric, symbolic, or any other suitable value.

In an embodiment, an ACH index score is calculated for every ACH originator within a user's purview. In embodiments, the user evaluating the ACH index score can make a determination based on the results of the ACH index score as to whether to enter into a credit transaction with the ACH originator, or as to what type of credit transaction to enter into. In an embodiment, the ACH index score takes into account the following data, although additional or fewer data can, of course, be considered: standard entry class code, standard entry class code return risk percentage, industry risk factors, origination set volume, origination set frequency, origination set aggregate peak exposure risk, third party financial information, public record information, economic risk metrics, and customized risk profile.

### Standard Entry Class (SEC) Code

In an embodiment, the index score is adjusted based upon the risk levels associated with the SEC codes specified for each origination set used by the originator, or the standard entry class codes. In an embodiment, higher risk SEC codes will have a negative impact on the index score. In embodiments, lower risk SEC codes will have a positive impact on the index score. For example, typical SEC codes can be: PPD—Prearranged Payment & Deposit; CCD—Cash Concentration and Disbursement Entry; TEL—Telephone Initiated Entry; WEB—Internet Initiated Entry; CTX—Corporate Trade Exchange Entry; ARC—Accounts Receivable Entry; BOC—Back Office Conversion Entry; POP—Point of Purchase Entry; RCK—Re-presentment Check Entry; CIE—Customer Initiated Entry; ONE—Death Notification Entry; ENR -Automated Enrollment Entry; IAT—International ACH Transaction; POS—Point-of-Sale Entry; XCK—Destroyed Check Entry; and X937—Imaged Electronic Deposit (For ROC Customers). In embodiments, North American Industry Class System Codes (NAICS) can be used in combination with SEC codes or evaluated on their own.

### Standard Entry Class Code Return Risk Percentage

In an embodiment, the index score is adjusted based on the historical industry return risk percentages according to SEC code. In embodiments, the return risk percentages are updated quarterly, although other updating frequencies are also considered. In an embodiment, higher risk levels are assigned to higher-risk SEC codes and their associated return codes. In embodiments, lower risk levels are assigned to lower-risk SEC codes and their associated return codes.

### Industry Risk Factors

In an embodiment, the index score is adjusted for ACH originators operating in higher risk standard industry class codes. For example, there will be a negative impact on the index score for those originators operating in high risk standard industry class codes. In embodiments, there will be a positive impact on the index score for those originators operating in low risk standard industry class codes.

### Origination Set Volume

In an embodiment, the index score is adjusted according to the origination set. For example, the index score is adjusted based upon the aggregate dollar amount volume assigned to the originator's ACH origination sets. In an embodiment, a high aggregate dollar amount volume for an originator's origination set imparts a negative impact on the index score for that originator. In an embodiment, a low aggregate dollar amount volume for an originator's origination set imparts a positive impact on the index score for that originator. In other embodiments, the positive and negative impacts based on aggregate dollar amount volume are reversed, depending on the industry.

### Origination Set Aggregate Peak Exposure Risk

In an embodiment, the index score is adjusted according to the origination set aggregate peak exposure risk. In an embodiment, aggregate peak exposure risk is calculated as associated with “user created” risk profiles. The index score is adjusted based upon the relationship between the aggregate peak exposure risk and unsecured trade limits computed within a particular account profile.

### Transaction Data

In an embodiment, the index score is adjusted according to actual transation data. For example, actual ACH transaction data can be uploaded into index scoring system 100 via user interface 104. In another embodiment, actual ACH transaction data can be obtained or incorporated into database 108 from a different source. In an embodiment, if the actual ACH transaction data reflects a negative pattern or history for the originator's transactions, there will be a negative impact on the index score. Conversely, if the actual ACH transaction data reflects a positive pattern or history for the originator's transactions, there will be a positive impact on the index score.

### Third Party Financial Information

In an embodiment, the index score is adjusted according to third party financial information. For example, unsecured payment information can be incorporated into the scoring calculation. In an embodiment, if the third party financial information reflects a negative pattern or history for the originator's transactions, there will be a negative impact on the index score. Conversely, if the third party financial information reflects a positive pattern or history for the originator's transactions, there will be a positive impact on the index score.

### Public Record Information

In an embodiment, the index score is adjusted according to public record information. For example, if the if the public record information reflects a negative pattern or history for the originator's transactions, there will be a negative impact on the index score. Conversely, if the public record information reflects a positive pattern or history for the originator's transactions, there will be a positive impact on the index score.

### Economic Risk Metrics

In an embodiment, the index score is adjusted according to economic risk metrics. For example, in an embodiment, if the originator is in a risky industry and/or location, there will be a negative impact on the index score. Conversely, if the originator is in a non-risky industry and/or location, there will be a positive impact on the index score. Other economic risk metrics can also be considered.

### Customized Risk Profile

In an embodiment, the index score is adjusted according to a customized risk profile. In an embodiment, each user can elect to change the risk tolerance level. For example, conservative, standard, or aggressive risk tolerances can be selected, according to the particular tolerance of the user. In embodiments, according to the risk tolerance level, all ACH originators are evaluated using consistent methodology, which is applied consistently throughout the organization.

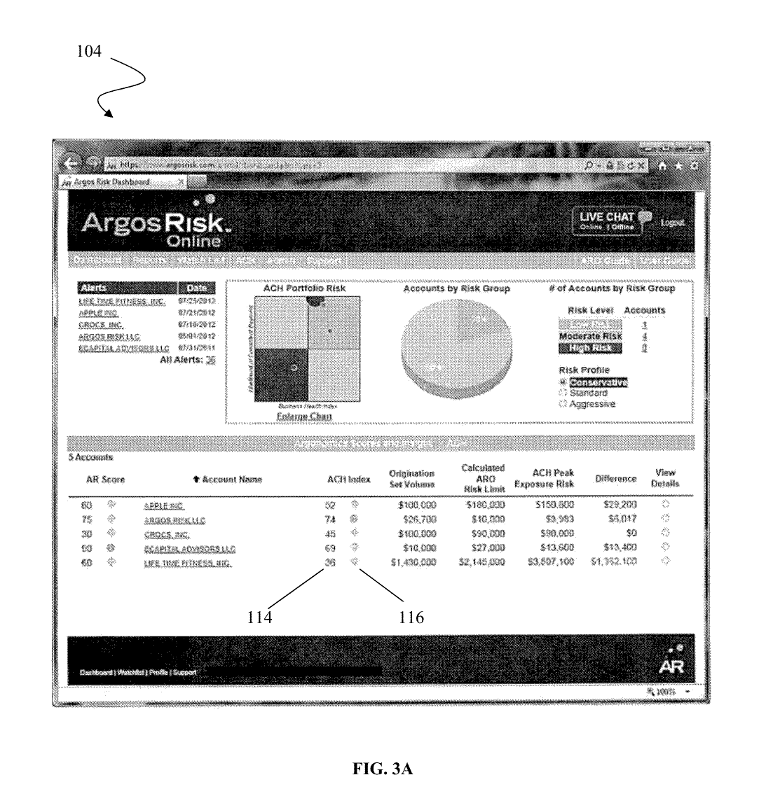

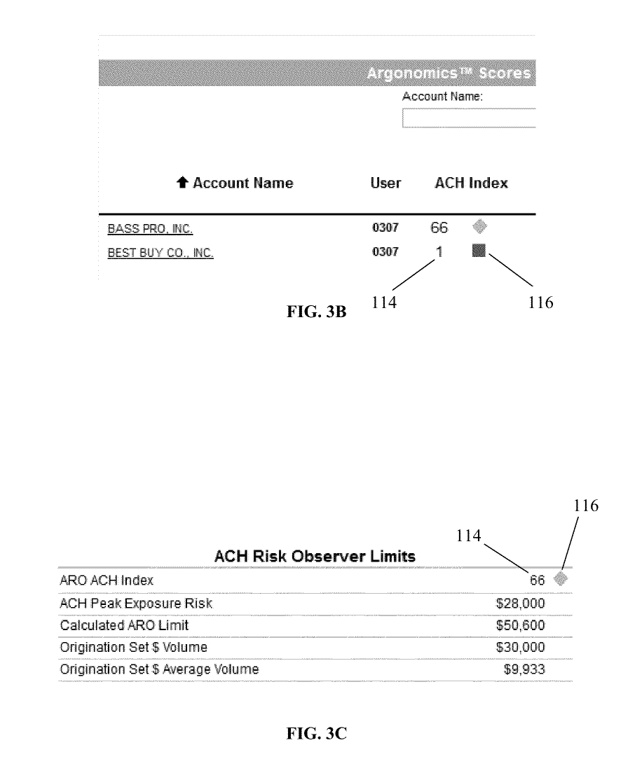

Referring to FIGS. 3A-3C, once an index score is calculated, the index score can be presented via user interface 104 in, for example, the web interface shown. For example, index score 114 is shown in user interface 104. In other embodiments, index score 114 can be presented via other interfaces. As depicted, an index score 114 is displayed for each of the ACH originators that is accessible to the user. As shown, user interface 104 can incorporate other related pieces of ACH data, as desired by the user.

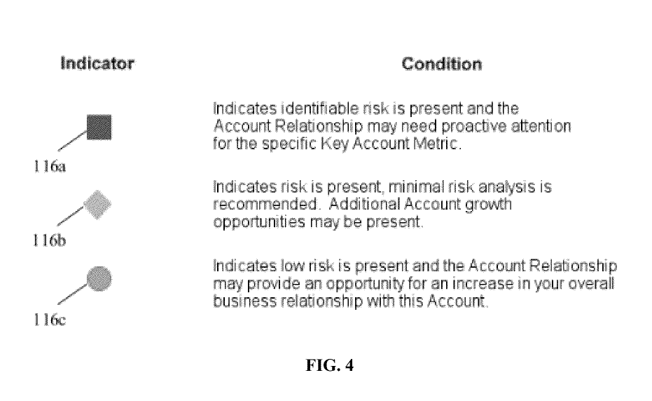

An indicator 116 can be displayed adjacent the index score 114 to provide an easily recognizable visual indication of the relative strength of the index score 114. Referring to FIG. 4, examples of individual indicators are shown. For example, indicator 116a is a red square. The indicator 116a illustrates that the identifiable risk is present and the account relationship may need proactive attention. In another example, indicator 116b is a yellow diamond. The indicator 116b illustrates that risk is present, and minimal risk analysis is therefore recommended. Further, additional account growth opportunities may be present. In another example, indicator 116c is a green circle. The indicator 116c illustrates that low risk is present, and the account relationship may provide an opportunity for an increase in the overall business relationship with the account. Other shapes and colors for indicators can, of course, be used, according to the application and region of indication. For example, triangles, ovals, parallelograms, pentagons, trapezoids, octagons, etc. can be used to indicate various levels of risk. Moreover, other definitions of risk based on the index score 114 and categories of indicators and conditions can be defined as desired.

In other embodiments, alerts can be provided via user interface 104 if the index score 114 changes, or changes in or out of a particular range. For example, a user would be alerted if the index score 114 for an ACH originator moved from a safer risk index score to a more risky index score. Conversely, a user can be alerted if the index score 114 for an ACH originator moved from a more risky index score to a safer risk index score. Such an alert can be provided by any suitable display, such as text, graphics, sound, or a combination thereof.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A method for calculating a numeric ACH score for an ACH originator, the method comprising:
evaluating a standard entry class code of the ACH originator;
evaluating a standard entry class code return risk percentage of the ACH originator;
evaluating one or more industry risk factors for the ACH originator;
evaluating an origination set volume for the ACH originator;
evaluating an origination set aggregate peak exposure risk for the ACH originator;
evaluating actual transaction data for the ACH originator;
evaluating third party financial data for the ACH originator;
evaluating public record data for the ACH originator;
evaluating one or more economic risk metrics for the ACH originator;
evaluating a customized risk profile for the ACH originator; and
displaying the calculated numeric ACH score.

2. The method of claim 1, further comprising updating the numeric ACH score if there is a change to one or more of the standard entry class code, standard entry class code return risk percentage, one or more industry risk factors, origination set volume, origination set aggregate peak exposure risk, actual transaction data, third party financial data, public record data, one or more economic risk metrics, or customized risk profile.

3. The method of claim 2, further comprising providing an alert based on the updated numeric ACH score.

4. The method of claim 1, wherein the calculated numeric ACH score is a number from 0 to 100, wherein 100 indicates low risk and 0 indicates significant potential risk.

5. The method of claim 4, wherein the calculated numeric ACH score is a fraction of a number.

6. A system for calculating a numeric index score for an ACH originator, the system comprising:
a processing engine configured to calculate the numeric index score, the processing engine including
a database configured to store at least one of a standard entry class code for the ACH originator, a standard entry class code return risk percentage for the ACH originator, one or more industry risk factors for the ACH originator, an origination set volume for the ACH originator, an origination set aggregate peak exposure risk for the ACH originator, actual transaction data for the ACH originator, third party financial data for the ACH originator, public record data for the ACH originator, one or more economic risk metrics for the ACH originator, or a customized risk profile for the ACH originator, and
a processor configured to execute database-specific calls to retrieve data from the database and evaluate the retrieved data to calculate the numeric index score for the ACH originator; and
a user interface operably coupled to the processing engine and configured to display the numeric index score.

7. The system of claim 6, wherein the user interface is further configured to display a graphical indication of the health of the numeric index score.

8. The system of claim 6, wherein the processor is further configured to determine if the retrieved data has changed and reevaluate the changed retrieved data to calculate an updated numeric index score.

9. The system of claim 7, wherein the user interface is further configured to display the updated numeric index score.

10. The system of claim 8, wherein the user interface is further configured to indicate an alert based on the updated numeric index score.

11. The system of claim 6, wherein the calculated numeric index score is a number from 0 to 100, wherein 100 indicates low risk and 0 indicates significant potential risk.

12. The system of claim 11, wherein the calculated numeric index score is a fraction of a number.

13. A method for managing credit risk associated with an ACH originator, the method comprising:
evaluating an ACH index score, the ACH index score calculated based on an evaluation of a standard entry class code of the ACH originator, a standard entry class code return risk percentage of the ACH originator, one or more industry risk factors for the ACH originator, an origination set volume for the ACH originator, an origination set aggregate peak exposure risk for the ACH originator, actual transaction data for the ACH originator, third party financial data for the ACH originator, public record data for the ACH originator, one or more economic risk metrics for the ACH originator, and a customized risk profile for the ACH originator; and
conducting a credit transaction with the ACH originator based on the ACH index score.

14. The method of claim 13, wherein the ACH index score is a number from 0 to 100, wherein 100 indicates low risk and 0 indicates significant potential risk.

15. The method of claim 14, wherein the ACH index score is a fraction of a number.

16. A method for generating an index score for an ACH originator, the method comprising:
evaluating at least one of a standard entry class code of the ACH originator, a standard entry class code return risk percentage of the ACH originator, one or more industry risk factors for the ACH originator, an origination set volume for the ACH originator, an origination set aggregate peak exposure risk for the ACH originator, actual transaction data for the ACH originator, third party financial data for the ACH originator, public record data for the ACH originator, one or more economic risk metrics for the ACH originator, or a customized risk profile for the ACH originator,
wherein the index score reflects the riskiness of entering into a credit transaction with the ACH originator.
